(19) United States
(12) Patent Application Publication
(10) Pub. No.: US 2015/0281058 A1
(43) Pub. Date: Oct. 1, 2015

(54) PSEUDO WIRE IN LAYER 2 VIRTUAL PRIVATE NETWORK

(71) Applicant: HANGZHOU H3C TECHNOLOGIES CO., LTD., Hangzhou, Zhejiang (CN)

(72) Inventor: Zhonghua Gao, Beijing (CN)

(21) Appl. No.: 14/440,301

(22) PCT Filed: Oct. 30, 2013
(86) PCT No.: PCT/CN2013/086187

§ 371 Date: May 1, 2015

(30) Foreign Application Priority Data
Nov. 6, 2012 (CN) 201210437365.1

(51) Int. Cl. H04L 12/721; H04L 29/12; H04L 12/46

(52) U.S. Cl. CPC H04L 45/68; H04L 12/4641; H04L 61/2007; H04L 45/66

(57) ABSTRACT

Based on an example of the present disclosure, setup messages are exchanged between Provider Edge (PE) devices via a bidirectional tunnel. The setup messages carry Pseudo Wire (PW) parameters to create a PW in a layer 2 virtual private network.

### BACKGROUND

A virtual private network (VPN) is commonly used by an organization to provide remote, secure access to its servers over a public network, such as the Internet, for its authorized users. A VPN enables a computer to communicate with servers in a private network over a public network by establishing a virtual point-to-point connection through the use of dedicated connections, encryption, or a combination of the two. VPNs may be layer 2 VPNs or layer 3 VPNs. A layer 3 VPN forwards packets based on layer 3 information, such as Internet Protocol (IP) addresses. A layer 2 VPN, i.e. L2VPN, forwards frames based on layer 2 information, such as media access control (MAC) addresses, virtual local area network (VLAN) IDs, etc.

### BRIEF DESCRIPTIONS OF THE DRAWINGS

Features of the present disclosure are illustrated by way of examples and not limited in the following drawings, in which like numerals indicate like elements:

FIG. 1 is a schematic diagram illustrating structure of an L2VPN network, in accordance with an example of the present disclosure.

FIG. 2 is a flowchart illustrating a method for creating a Pseudo Wire (PW) in an L2VPN network, in accordance with an example of the present disclosure.

FIG. 3 is a flowchart illustrating a method for removing a PW in an L2VPN network, in accordance with an example of the present disclosure.

FIG. 4 is a flowchart illustrating another method for removing a PW in an L2VPN network, in accordance with an example of the present disclosure.

FIG. 5 is a flowchart illustrating a method for providing notification of a PW failure in an L2VPN network, in accordance with an example of the present disclosure.

FIG. 6 is a schematic diagram illustrating format of a protocol message packet, in accordance with an example of the present disclosure.

FIG. 7 is a schematic diagram illustrating format of a G-ACH based PW Protocol (GBPP) Protocol field in the format of the protocol message packet shown in FIG. 6.

FIG. 8 is a flowchart illustrating a successful PW creation, which is negotiated by Provider Edge (PE) 1 and PE 2 in the network shown in FIG. 1.

FIG. 9 is a flowchart illustrating a failed PW creation, which is negotiated by PE 1 and PE 2 in the network shown in FIG. 1.

FIG. 10 is a flowchart illustrating a removal of a PW, which is negotiated by PE 1 and PE 2 in the network shown in FIG. 1.

FIG. 11 is a schematic diagram illustrating structure of a PE device in an L2VPN network, in accordance with an example of the present disclosure.

FIG. 12 is a schematic diagram illustrating another structure of a PE device in an L2VPN network, in accordance with an example of the present disclosure.

### DETAILED DESCRIPTION

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. In addition, the terms “a” and “an” are intended to denote at least one of a particular element.

A PW is an emulation of a point-to-point connection over a network. Label Distribution Protocol (LDP) or Border Gateway Protocol (BGP) signaling protocols may be used to allocate a Virtual Circuit (VC) label for the PW, and inform a peer end PE device about the allocated VC label, so as to establish a unidirectional VC, and the PW.

Processes for creating a PW with the LDP and BGP signaling protocols are now described, taking Virtual Private Local Area Network Service (VPLS) technologies as an example.

A mode for creating a PW, which uses LDP as a PW signaling protocol, is a Martini mode. The process for creating a PW with the LDP signaling protocol may be as follows.

(1) After associating a PE device with a specific Virtual Switch Instance (VSI), a Downstream Unsolicited (DU) mode of the LDP may be employed to actively transmit a label mapping message to a peer end PE device. The label mapping message may include a PWID Forwarding Equivalence Class (FEC), a VC label binding with the PWID FEC, and an interface parameter (such as a Maximum Transmission Unit (MTU), and so on).

(2) When the peer end PE device has been associated with the specific PWID, the peer end PE device may accept the label mapping message, and reply to the label mapping message of the PE device at the other side.

(3) After being created successfully, a pair of unidirectional VCs may be combined to form a bidirectional PW. The bidirectional PW may be taken as a virtual Ethernet interface of the VSI.

The foregoing Martini mode may be implemented easily, but problems generated by the Martini mode are as follows. The Public Network (PN) must be an Internet Protocol (IP) network environment. The PE device needs to run an LDP signaling protocol. The PW parameters, i.e., PW ID, and the IP address of the peer end PE device of the PW, should be configured manually since the LDP cannot provide an auto-discovery mechanism for the peer end PE device of a VPLS instance. Thus, each peer end PE device for the PE device is manually configured. When a new PE device joins, each PE device needs to modify its configuration parameters.

A mode for creating a PW, which uses BGP as the PW signaling protocol is Kompella mode. The process for creating a PW by utilizing the BGP signaling protocol may be as follows.

(1) A PE device may utilize an Update message of the BGP to transmit a VE ID and label block information to all of the peer end PE devices. The VPLS Edge device (VE) ID is a unique number of each site connecting with the PE device in a VPN, which is planned by a Service Provider (SP). A label block may include a group of continuous labels.

(2) After receiving the Update message, a peer end PE device may calculate a unique label value, based on the VE ID of the peer end PE device and the label block in the Update message, and take the unique label value as the VC label. Simultaneously, the peer end PE device, which has received the Update message, may learn information, such as a VC label value of the PE device at the opposite side, based on the VE ID in the Update message and a local label block, that is, the label block of the peer end PE device.

(3) Two PE devices may transmit the Update message to each other, and calculate the VC label. Subsequently, the PW between the two PE devices may be successfully created.

In the Kompella mode, the auto-discovery of peer end PE device of a VPLS instance may be implemented, by configuring a VPN Target. Manual configuration is no longer necessary, when adding or removing a PE device, thus providing better scalability. However, the following problems may also exist. The PN must be an IP network. The PE device needs to run the BGP protocol, which is very complicated. Also, the BGP protocol must support an L2VPN address family, and it is still necessary to manually configure the following parameters, such as a Route Target (RT), a Route Distinguisher (RD) and a Connection, which are employed by the VPN.

When using the Martini mode or the Kompella mode for PW creation, the following problems may occur: (1) The PN must be an IP network (The foregoing PW creation methods don't apply to a network environment, in which the PN is a non-IP network); (2) it is necessary to be supported by complicated signaling protocol of control panel, such as LDP or BGP; and (3) there is a certain degree of complexity when configuring and deploying.

The following examples in the present disclosure provide a method for creating a PW in an L2VPN network, and a PE device which may apply the foregoing methods. In the following examples, firstly, a bidirectional tunnel across the PN may be deployed between any two PE devices, and then, each PE device may transmit a protocol message, which is used for creating a PW, to the other PE device via the connected bidirectional tunnel, so as to create the PW. The following examples are also used in a network environment which uses a non-IP network as the PN, and do not need to be supported by a complicated signaling protocol, such as LDP or BGP, of a control plane.

Also, as is further described below, a bidirectional tunnel and a PW are created between PE devices. The bidirectional tunnel and PW may satisfy the following conditions.

(1) One bidirectional tunnel may simultaneously bear multiple PWs, that is, a bidirectional tunnel between two PE devices may simultaneously bear multiple PWs between the two PE devices.

(2) PE devices at both ends of one PW may be configured with a same PW ID.

(3) PW ID of a PW in a same bidirectional tunnel is unique. PW IDs of PWs in different bidirectional tunnels may be the same.

In view of above, the following technical effects may be achieved by the foregoing examples of the present disclosure.

(1) Since a bidirectional tunnel across a PN may be deployed between any two PE devices, a simple and convenient PW creating method may be implemented, by utilizing a band control channel of the bidirectional tunnel. A complicated control plane protocol, such as LDP or BGP, is no longer necessary. A PW may be created based on negotiation with a bidirectional tunnel between PE devices, the implementation may be easier.

(2) Since a bidirectional tunnel across a PN is deployed between any two PE devices, two PE devices may transmit a protocol message to each other, by using the bidirectional tunnel between them. Thus, it is not necessary for the protocol message transmitted between two PE devices to carry information, such as the IP address of peer end PE device. The bidirectional tunnel may cross a PN of IP protocol, or cross a PN of non-IP protocol. That is, the foregoing examples of the present disclosure may be applied to a network environment, in which the PN is a non-IP network, e.g., an MPLS-Transmit Profile (TP) network environment.

(3) Configurations may be simpler. Parameters, such as PW ID, PW type and Virtual Circuit Connectivity Verification (VCCV) parameter of a PW may be negotiated automatically. It is not necessary to manually configure parameters, such as PW ID of a PW, and IP address of a peer end PE device of a PW, as may be done for the LDP signaling protocol. It is also not necessary to manually configure parameters, such as RT, RD, Connection, used by a VPN, as may be done for the BGP signaling protocol.

(4) A configuration mode may be employed which directly associates an L2VPN with the bidirectional tunnel. The address of peer end PE device and tunnel iteration are no longer necessary.

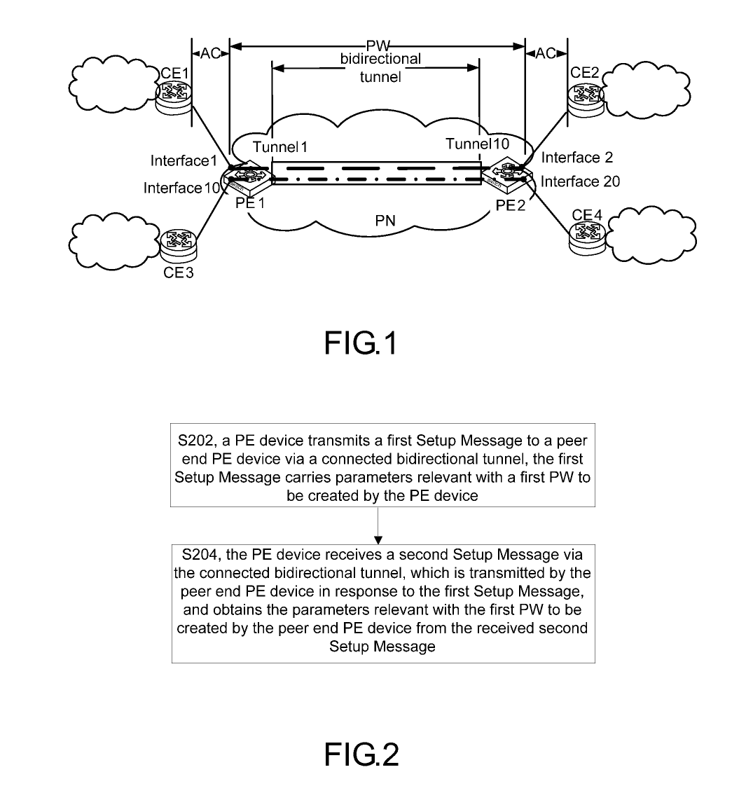

As shown in FIG. 1, in the L2VPN network, a bidirectional tunnel between two PE devices is deployed across the PN, in which the bidirectional tunnel connects the two PE devices with each other. For example, the bidirectional tunnel may be a Traffic Engineering (TE) bidirectional tunnel, a Generic Routing Encapsulation (GRE) tunnel or a Multi-Protocol Label Switching (MPLS) tunnel, and so on. The bidirectional tunnel may cross an IP PN, or cross a non-IP PN.

FIG. 2 shows an example of a method for PW creation in an L2VPN network, and the method may be executed by any PE device.

At block S202, a PE device may transmit a first setup message to a peer end PE device via a connected bidirectional tunnel. The first setup message may carry PW parameters, which are relevant with a first PW to be created by the PE device.

After receiving the first setup message via the connected bidirectional tunnel, the peer end PE device may match the PW parameters carried in the first setup message with PW parameters configured by the peer end PE device, which are relevant to all of the PWs to be created by the peer end PE device. When the matching is successful, (e.g., the PW parameters carried in the first setup message and configured by the peer end PE device are the same) the peer end PE device may return a second setup message to the PE device, via the connected bidirectional tunnel. The returned second setup message may carry PW parameters relevant to the first PW, which are configured by the peer end PE device. When the matching is failed (e.g., the peer end PE device does not configure a PW with all the PW parameters carried in the first setup message), the peer end PE device may return a Notify Message to the PE device via the connected bidirectional tunnel, so as to inform the PE device that creation of the first PW is failed.

It should be noted that, the foregoing first PW may be any PW to be created by the PE device, which doesn't refer to a certain PW. The first PW is named for convenience of description.

At block S204, the PE device may receive the second setup message from the peer end PE device via the connected bidirectional tunnel, which is in response to the first setup message, and obtain from the received second setup message the PW parameters, which are relevant with the first PW to be created by the peer end PE device.

The PW relevant parameters carried by the first Setup Message and the second Setup Message may include: PW information, an interface parameter and a VCCV parameter. The PW information may include a PW ID, a PW type, a PW receiving label, and so on. The interface parameter may include a Maximum Transmission Unit (MTU), a Request Virtual LAN (VLAN) ID, and so on. The VCCV parameter may include a control channel and detecting mode used by the PW detection. Subsequently, parameters, such as the label, type and VCCV parameters of the PW to be created may be negotiated.

In the foregoing example of the present disclosure, a bidirectional tunnel across the PN is deployed between any two PE devices. Before creating the PW, the PE device may transmit the first Setup Message to the peer end PE device via the connected bidirectional tunnel, in which the first Setup Message carries PW parameters relevant with the first PW to be created by the PE device. The PE device may also receive the second Setup Message returned by the peer end PE device. The second Setup Message carries PW parameters, which are relevant with the first PW and are configured by the peer end PE device. Subsequently, the PE device may learn the PW parameters relevant with the first PW, which are configured by the PE device and the peer end PE device. Thus, the first PW may be created successfully between the PE device and the peer end PE device. Since a bidirectional tunnel may be deployed between any two PE devices, a PE device may transmit the first Setup Message to a peer end PE device via the connected bidirectional tunnel. The first Setup Message may carry PW parameters, which are relevant with the first PW to be created by the PE device. The PE device may also receive PW parameters, which are relevant with the first PW and configured by the peer end PE device, from the peer end PE device via the connected bidirectional tunnel. That is, two PE devices may transmit a protocol message to each other via the bidirectional tunnel between them. Therefore, it is not necessary for the protocol message transmitted between the two PE devices to carry information, such as the IP address of peer end PE device. The bidirectional tunnel may cross the PN of IP protocol, or cross the PN of non-IP protocol. That is, the technical solution provided by the example of the present disclosure may be applied to a network environment of non-IP protocol, which doesn't require that the PN an IP network.

In addition, in the example of the present disclosure, a complicated signaling protocol of the control plane, such as LDP or BGP, is no longer necessary. A PW may be created based on negotiation using the bidirectional tunnel between PE devices. The implementation may be easier. Furthermore, configurations may be simpler. Parameters, such as PW ID, PW type and PW VCCV parameters, may be negotiated automatically. It is not necessary to manually configure parameters, such as PW ID, and IP address of the peer end PE device of the PW, like the LDP signaling protocol. It is also not necessary to manually configure parameters, such as RT, RD and Connection used by the VPN, like the BGP signaling protocol.

Similarly, when the peer end PE device executes the foregoing blocks S202˜S204, the PE device may also receive a third Setup Message via the connected bidirectional tunnel, which is actively transmitted by the peer end PE device. Subsequently, the PE device may match PW parameters in the received third Setup Message, which are relevant with a second PW to be created by the peer end PE device, with PW parameters, which are configured by the PE device and relevant to all of the PWs to be created by the PE device. When the matching is successful, the PE device may return a fourth Setup Message to the peer end PE device via the connected bidirectional tunnel. The returned fourth Setup Message may carry PW parameters, which are relevant with the second PW and configured by the PE device. When the matching is failed, the PE device may return a Notify Message to the peer end PE device via the connected bidirectional tunnel, so as to inform the peer end PE device that creation of the second PW is failed.

The foregoing second PW doesn't refer to a certain PW, which may be any PW to be created by the peer end PE device.

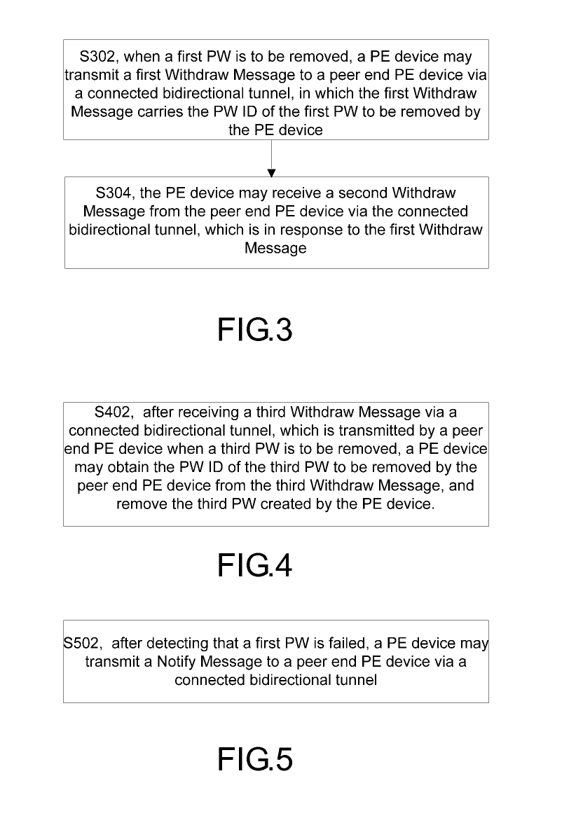

When it is necessary to remove a PW created by the PE device, the PE device may transmit a Withdraw Message to the peer end PE device via the connected bidirectional tunnel, so as to inform the peer end PE device about the PW ID of the PW to be removed by the PE device. Specifically speaking, as shown in FIG. 3, the PE device may execute the following blocks.

At block S302, when the first PW is to be removed, the PE device may transmit a first Withdraw Message to the peer end PE device via the connected bidirectional tunnel. The first Withdraw Message carries the PW ID of the first PW to be removed by the PE device.

After receiving the first Withdraw Message via the connected bidirectional tunnel, the peer end PE device may obtain the PW ID of the first PW to be removed by the PE device from the first Withdraw Message, so as to remove the first PW created by the peer end PE device. Subsequently, the peer end PE device may return a second Withdraw Message to the PE device via the connected bidirectional tunnel, so as to inform the PE device that the peer end PE device has received the first Withdraw Message from the PE device.

At block S304, the PE device may receive the second Withdraw Message from the peer end PE device via the connected bidirectional tunnel, which is in response to the first Withdraw Message. Subsequently, the PE device may learn that the peer end PE device has received the first Withdraw Message.

In addition, when a third PW (which may be any PW created by the peer end PE device) is to be removed by the peer end PE device, the peer end PE device may actively transmit a third Withdraw Message to the PE device. At this time, as shown in FIG. 4, the PE device may execute the following blocks.

At block S402, after receiving the third Withdraw Message via the connected bidirectional tunnel, which is transmitted by the peer end PE device when the third PW is to be removed, the PE device may obtain the PW ID of the third PW to be removed by the peer end PE device from the third Withdraw Message, and remove the third PW created by the PE device.

When finding that a PW created by the PE device is failed, the PE device may actively transmit a Notify Message to the peer end PE device via the connected bidirectional tunnel, so as to inform the peer end PE device about status information of the failed PW. Specifically speaking, as show in FIG. 5, the PE device may execute the following blocks.

At block S502, after detecting that the first PW is failed, the PE device may transmit the Notify Message to the peer end PE device via the connected bidirectional tunnel. The Notify Message may carry status information of the failed first PW, e.g., a status code of the PW.

After receiving the Notify Message via the connected bidirectional tunnel, the peer end PE device may learn that the first PW is failed and may learn corresponding status information. The peer end PE device may also return a reply message, which indicates that the peer end PE device has received the Notify Message.

Similarly, when detecting that a created PW is failed, the peer end PE device may also execute foregoing block S502. At this time, the PE device may receive the Notify Message from the peer end PE device via the connected bidirectional tunnel, and learn status information of the failed PW of the peer end PE device from the Notify Message.

Taking security into consideration, the foregoing Setup Message, Notify Message and Withdraw message may also carry ID information of a first PE device transmitting the protocol message. After receiving the protocol message, a second PE device may firstly perform an identity authentication on the first PE device transmitting the protocol message, based on the ID information carried in the protocol message. When the identity authentication is successful, subsequent processes may be executed. Otherwise, the protocol message may be discarded. Thus, authentication functions may be implemented.

After creating a PW with the foregoing method, or before creating a PW, a PE device may also associate an interface connecting the PE device to a Customer Edge (CE) device, a PW corresponding to a VPN of the CE device, and an interface connecting the PE device to the bidirectional tunnel with each other. Thus, after creating the PW, a user packet coming from the CE device may be transmitted to the peer end PE device via the PW in the bidirectional tunnel.

The foregoing PW creation method may be considered a PW signaling protocol, which is carried in a Generic Associated Channel (G-ACH) of the bidirectional tunnel. Therefore, the protocol may be referred to as a G-ACH based Pseudowire Protocol (GBPP).

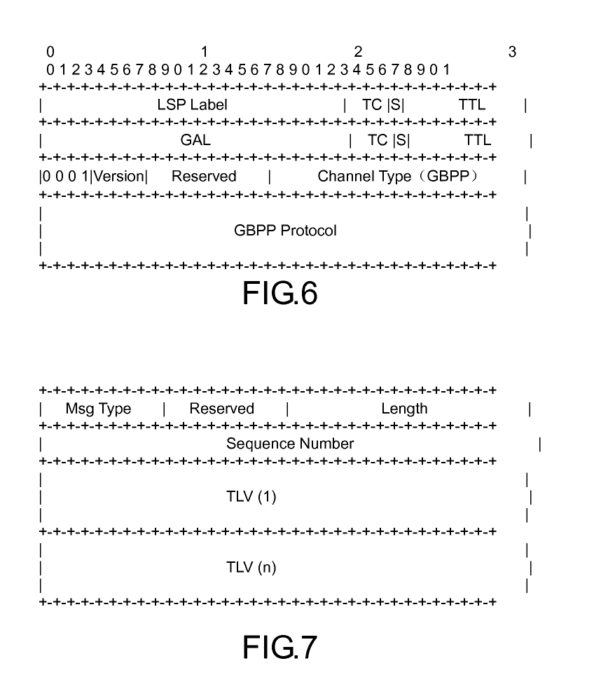

When the bidirectional tunnel is a TE bidirectional tunnel, packet encapsulation mode of the protocol message, such as the foregoing Setup Message, the Withdraw Message and the Notify message may be as shown in FIG. 6.

In FIG. 6, Channel Type field is configured to indicate a protocol type of the message. When the Channel Type field is set to be a specific value, it means that the message is a GBPP protocol message (including the Setup Message, the Withdraw Message and the Notify Message). The specific value may be allocated by an Internet Assigned Numbers Authority (IANA).

The GBPP Protocol field is configured to carry specific contents of the GBPP protocol message, which may be designed using a Tag Length Value (TLV) mode. There are three message types. That is, Setup, Withdraw and Notify. The specific format of the field is shown in FIG. 7.

In FIG. 7, Msg Type field is configured to indicate a message type. When the value of the Msg field is set to be 1, it means that the message is the Setup Message. When the value of the Msg field is set to be 2, it means that the message is the Withdraw Message. When the value of the Msg field is set to be 3, it means that the message is the Notify Message.

The type and contents of the TLV field are as follows.

(1) PW TLV is configured to carry PW information. The PW information includes a PW ID, a PW type and a PW receiving label.

(2) Interface Parameter TLV is configured to carry an interface parameter, that is, a parameter of an interface corresponding to the PW. The interface parameter includes an MTU, a Request VLAN ID, and so on.

(3) VCCV TLV is configured to carry a detecting mechanism parameter of the PW, which includes a control channel and detection mode used by the PW detection.

(4) PW Status TLV is configured to carry PW status information, which includes a status code of the PW.

(5) Error TLV is configured to carry error information of protocol processing, which includes an error code of message processing.

(6) Authentication TLV is configured to carry ID information, which includes an authentication abstract, such that an attack may be avoided.

(7) Ack TLV is configured to carry a Sequence Number of a received message.

The TLV, which may be included by each protocol message, is shown in Table 1.

TABLE 1

| | | Interface | | PW | | Authen- | |
|---|---|---|---|---|---|---|---|
| | PW | Parameter | VCC | Status | Error | tication | Ack |
| | TLV | TLV | VTLV | TLV | TLV | TLV | TLV |
| Setup | ✓ | ✓ | ✓ | | | ✓ | ✓ |
| Message | | | | | | | |
| Withdraw | ✓ | | | | | ✓ | ✓ |
| Message | | | | | | | |
| Notify | | | | ✓ | ✓ | ✓ | ✓ |
| Message | | | | | | | |

The Setup Message, Withdraw Message and Notify Message used for a response may carry Ack TLV. The Setup Message, Withdraw Message and Notify Message actively transmitted may not carry the Ack TLV.

Take the network shown in FIG. 1 as an example, in FIG. 1, a TE bidirectional tunnel across the PN is deployed between PE 1 and PE 2. An interface of PE 1 connecting with the bidirectional tunnel is Tunnel 1. An interface of PE 2 connecting with the bidirectional tunnel is Tunnel 10. PE 1 connects with CE 1 and CE 3. PE 2 connects with CE 2 and CE 4. A site located by CE 1 and a site located by CE 2 belong to VPN 1 (L2VPN). A site located by CE 3 and a site located by CE 4 belong to VPN 2 (L2VPN). An interface of PE 1 connecting with CE 1 is Interface 1. An interface of PE 1 connecting with CE 3 is Interface 10. An interface of PE 2 connecting with CE 2 is Interface 2. An interface of PE 2 connecting with CE 4 is interface 20.

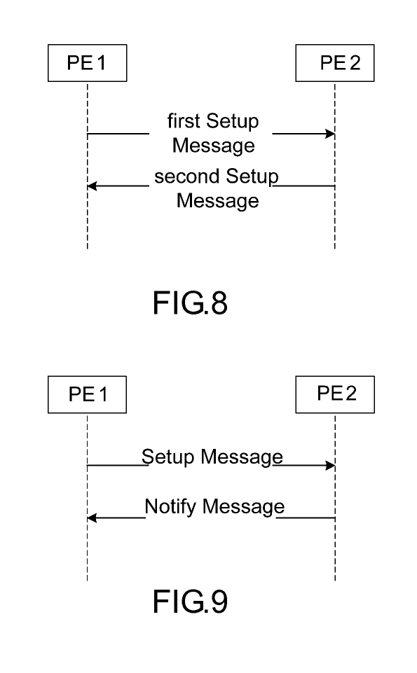

As shown in FIG. 8, PE 1 is configured to execute blocks S202 to S204 in the foregoing method, and is configured to transmit the first Setup Message to PE 2 via the TE bidirectional tunnel. The first Setup Message carries PW parameters, which are relevant with PW 1 (corresponding to VPN 1) to be created by PE 1. After receiving the first Setup Message via the TE bidirectional tunnel, PE 2 may match the PW parameters relevant to PW1 carried in the first Setup Message with PW parameters, which are relevant to all of the PWs configured by PE 2. When the matching is successful (the PW parameters which are relevant to PW 1 and configured by PE 2 are matched), PE 2 may return a second Setup Message to PE 1 via the TE bidirectional tunnel. The second Setup Message carries PW parameters, which are relevant to PW 1 and are configured by PE 2. When the matching is not successful, e.g., PE 2 doesn't configure PW parameters relevant with PW 1, as shown in FIG. 9, PE 2 may return a Notify Message to PE 1 via the TE bidirectional tunnel. The Notify Message carries processing error information, indicating which parameter is not matched. Subsequently, PE 1 may learn that PW 1 is not successfully created and failure reasons.

Similarly, PE 1 may also create PW2 (corresponding to VPN 2) with PE 2, based on the foregoing method, which is not repeated here.

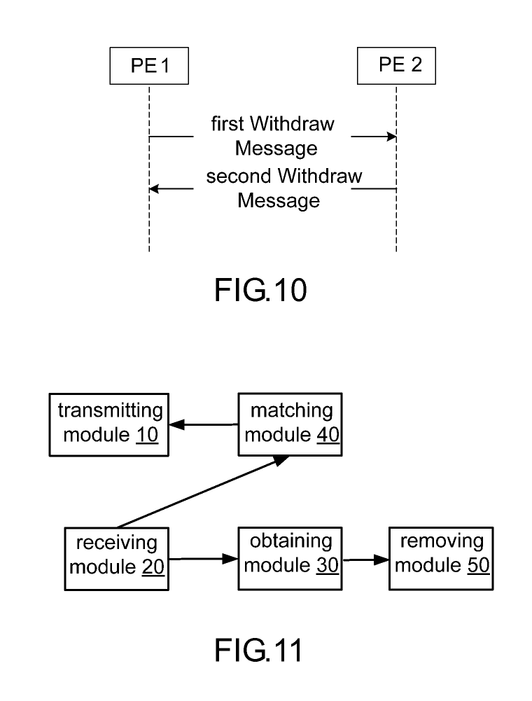

As shown in FIG. 10, after PW 1 and PW 2 are created successfully, when PE 1 is going to remove PW 1, the foregoing blocks S302 to S304 may be executed. PE 1 may transmit the first Withdraw Message to PE 2 via the TE bidirectional tunnel. The first Withdraw Message may carry the PW ID of PW 1 to be removed. After receiving the first Withdraw Message via the TE bidirectional tunnel, PE 2 may learn that PE 1 is going to remove PW 1, and remove PW 1 configured by PE 2. PE 2 may also return a second Withdraw Message to PE 1 via the TE bidirectional tunnel, so as to inform PE 1 that PE 2 has received the first Withdraw Message transmitted by PE 1.

When detecting that PW 1 is failed, PE 1 may execute foregoing block S502. That is, PE 1 may transmit the Notify Message to PE 2 via the bidirectional tunnel. The Notify Message may carry status information of PW 1. After receiving the Notify Message via the bidirectional tunnel, PE 2 may learn the status information of PW 1, and execute a corresponding operation. Subsequently, PE 2 may return a reply message to PE 1 via the bidirectional tunnel, so as to inform PE 1 that PE 2 has received the Notify Message.

When associating the interface of the PE device connecting with the CE device, the PW corresponding to the VPN of the CE device, and the interface of the bidirectional tunnel connecting to the PE device with each other, the following method may be employed to implement the configuration. Configurations of VPN 1 may be as follows: PW ID and egress interface of Interface 1 of PE 1 are respectively configured to be 1 and Tunnel 1 (associate Interface 1, PW 1 and Tunnel 1 with each other); and PW ID and egress interface of Interface 2 of PE 2 are respectively configured to be 1 and Tunnel 10 (associate Interface 2, PW 1 and Tunnel 10 with each other). Configurations of VPN 2 may be as follows: PW ID and egress interface of Interface 10 of PE 1 are respectively configured to be 2 and Tunnel 1 (associate Interface 10, PW 2 and Tunnel 1 with each other); and PW ID and egress interface of Interface 20 of PE 2 are respectively configured to be 2 and Tunnel 10 (associate Interface 20, PW 2 and Tunnel 10 with each other).

For the foregoing method, the following example of the present disclosure provides a PE device, which may apply the foregoing method. As shown in FIG. 11, in the example of the present disclosure, a bidirectional tunnel is deployed between PE devices in an L2VPN network. Each PE device may include a transmitting module 10, a receiving module 20, an obtaining module 30 and a matching module 40.

The transmitting module 10 in a PE device is configured to transmit a first Setup Message to a peer end PE device, via the bidirectional tunnel connecting with the PE device. The first Setup Message carries PW parameters relevant with a first PW to be created by the PE device. The matching module 40 determines whether the PW parameters relevant with a first PW match PW parameters configured by the PE device. When the matching performed by the matching module 40 is successful, the transmitting module 10 is further configured to return a second Setup Message to the peer end PE device, via the bidirectional tunnel connecting with the PE device. The returned second Setup Message carries PW parameters relevant with a second PW configured by the PE device. When the matching performed by the matching module 40 is failed (e.g., the matching is not successful), the transmitting module 10 is further configured to return a Notify Message to the peer end PE device, via the bidirectional tunnel connecting with the PE device, so as to inform the peer end PE device that creation for the second PW is failed.

The receiving module 20 in the PE device is configured to receive the second Setup Message in response to the first Setup Message received from the transmitting module 10. The second Setup Message is transmitted by the peer end PE device via the bidirectional tunnel connecting with the PE device. The receiving module 20 in the PE device is further configured to receive a third Setup Message, which is actively transmitted by the peer end PE device, via the bidirectional tunnel connecting with the PE device.

The obtaining module 30 in the PE device is configured to obtain PW parameters, which are relevant with the first PW to be created by the peer end PE device, from the third Setup Message received by the receiving module 20.

The matching module 40 in the PE device is configured to match PW parameters, which are relevant to the second PW to be created by the peer end PE device, in the third Setup Message actively transmitted by the peer end PE device, with PW parameters, which are relevant to all of the PWs to be created by the PE device and are configured by the PE device.

The PW relevant parameters carried in the first Setup Message, the second Setup Message and third Setup Message may include PW information, an interface parameter and a VCCV parameter. The PW information may include a PW ID, a PW type and a PW receiving label.

When the PE device is going to remove the first PW, the transmitting module 10 is further configured to transmit a first Withdraw Message to the peer end PE device, via the bidirectional tunnel connecting with the PE device. The first Withdraw Message may carry the PW ID of the first PW to be removed by the PE device.

The receiving module 20 is further configured to receive a second Withdraw Message, which is in response to the first Withdraw Message received from the transmitting module 10, from the peer end PE device via the bidirectional tunnel connecting with the PE device. The receiving module 20 is further configured to receive a third Withdraw Message, which is transmitted by the peer end PE device via the bidirectional tunnel connecting with the PE device, when the peer end PE device is going to remove a third PW.

The obtaining module 30 is further configured to obtain the PW ID of the third PW, which is to be removed by the peer end PE device, from the third Withdraw Message received by the receiving module 20. The third Withdraw Message is transmitted by the peer end PE device, when the peer end PE device is going to remove the third PW.

A removing module 50 is configured to remove the third PW created by the PE device, based on the PW ID of the third PW to be removed by the peer end PE device. The PW ID of the third PW has been obtained by the obtaining module 30.

The PE device may include other modules not shown that perform the functions described herein, such as associating an interface connecting the PE device to a CE device, a PW corresponding to a VPN of the CE device, and an interface connecting the PE device to the bidirectional tunnel with each other.

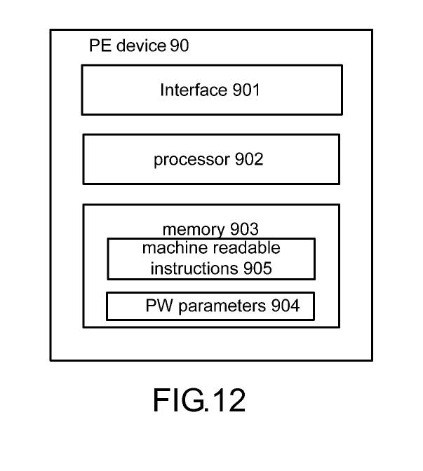

FIG. 12 is a schematic diagram illustrating another structure of a PE device in an L2VPN network, in accordance with an example of the present disclosure. As shown in FIG. 12, PE device 90 at least includes an interface 901, a processor 902 and a memory 903. The memory 903 may store PW parameters 904 which may include PW parameters received from another PE device to establish a PW and may also include PW parameters configured by the PE device 90 to create the PW. The memory 903 may store machine readable instructions 905 executed by the processor 902 to perform the functions described herein including the functions of the modules 10-50 described above with respect to FIG. 11 and other functions to create and manage a PW.

Interface 901 is configured to transmit a first Setup Message to a peer end PE device, via a bidirectional tunnel connecting with PE device 90. The first Setup Message carries PW parameters relevant with a first PW to be created by PE device 90. When PE device 90 has received a third Setup Message actively transmitted by the peer end PE device, in which the third Setup Message carries PW parameters relevant with a second PW to be created by the peer end PE device, and when the PW parameters relevant with the second PW are matched successfully by PE device 90, interface 901 is further configured to return a fourth Setup Message to the peer end PE device via the bidirectional tunnel connecting with PE device 90. The returned fourth Setup Message carries PW parameters relevant with the second PW, which are configured by PE device 90. When PE device 90 matches PW parameters carried in the third Setup Message actively transmitted by the peer end PE device, in which the PW parameters are relevant with the second PW to be created by the peer end PE device, and when the matching is failed, interface 901 is further configured to return a Notify Message to the peer end PE device, via the bidirectional tunnel connecting with PE device 90, so as to inform the peer end PE device that creation of the second PW is failed.

Interface 901 is further configured to receive a second Setup Message from the peer end PE device, which is in response to the first Setup Message transmitted by PE device 90, via the bidirectional tunnel connecting with PE device 90.

Memory 903 is configured to store PW parameters, which are relevant with all of the PWs to be created by PE device 90.

Processor 902 is configured to enable the first Setup Message to carry PW parameters, which are relevant with the first PW to be created by PE device 90, and transmit the first Setup Message to the peer end PE device via interface 901 and bidirectional tunnel connecting with PE device 90. Processor 902 is further configured to match the PW parameters, which are relevant with the second PW to be created by the peer end PE device, in the third Setup Message actively transmitted by the peer end PE device, with PW parameters relevant with all of the PWs to be created by PE device 90, which are configured by PE device 90 and are stored in memory 903.

The PW relevant parameters carried in the foregoing first, second, third and fourth Setup Messages may include PW information, an interface parameter, and a VCCV parameter. The PW information includes a PW ID, a PW type and a PW receiving label.

In addition, when PE device 90 is going to remove the first PW, interface 901 is further configured to transmit a first Withdraw Message to the peer end PE device, via the bidirectional tunnel connecting with PE device 90. The first Withdraw Message carries the PW ID of the first PW to be removed by PE device 90.

Interface 901 is further configured to receive a second Withdraw Message via the bidirectional tunnel connecting with PE device 90, in which the second Withdraw Message is transmitted by the peer end PE device and is in response to the first Withdraw Message. Interface 901 is further configured to receive a third Withdraw Message via the bidirectional tunnel connecting with PE device 90, in which the third Withdraw Message is transmitted by the peer end PE device, when the peer end PE device is going to remove a third PW.

Processor 902 is further configured to obtain the PW ID of the third PW to be removed by the peer end PE device from the third Withdraw Message received via interface 901, in which the third Withdraw Message is transmitted by the peer end PE device, when the peer end PE device is going to remove the third PW. Processor 902 is further configured to remove the third PW created by PE device 90, based on the obtained PW ID of the third PW to be removed by the peer end PE device.

Processor 902 is further configured to associate an interface connecting PE device 90 to a CE device, a PW corresponding to a VPN of the CE device, and an interface connecting PE device 90 to the bidirectional tunnel with each other.

What has been described and illustrated herein are examples of embodiments of the disclosure. The terms, descriptions and figures used herein are set forth by way of illustration only and are not meant as limitations. Many variations are possible within the spirit and scope of the disclosure, which is intended to be defined by the following claims and their equivalents.

1. A method for creating a Pseudo Wire (PW) in a Layer 2 Virtual Private Network (L2VPN) network, wherein a bidirectional tunnel is deployed between a Provider Edge (PE) device and a peer end PE device in the L2VPN network, and the method comprises:
transmitting, by the PE device, a first setup message to the peer end PE device via the bidirectional tunnel, wherein the first setup message carries first PW parameters relevant with a first PW to be created by the PE device;
receiving, by the PE device, a second setup message from the peer end PE device via the bidirectional tunnel, in response to the first setup message; and
obtaining second PW parameters relevant with the first PW from the received second setup message, wherein the second setup message is transmitted by the peer end PE device if the first PW parameters match the second PW parameters, which are configured by the peer end PE device to create PWs.

2. The method according to claim 1, further comprising:
after receiving a third setup message transmitted from the peer end PE device via the bidirectional tunnel, matching, by the PE device, third PW parameters, which are relevant to a second PW to be created by the peer end PE device and are carried in the received third setup message, with fourth PW parameters, which are relevant to all of the PWs to be created by the PE device and are configured by the PE device;
if the matching is successful, returning, by the PE device, a fourth setup message to the peer end PE device via the bidirectional tunnel, wherein the returned fourth setup message carries fifth PW parameters, which are relevant to the second PW and are configured by the PE device; and
if the matching is failed, returning, by the PE device, a Notify Message to the peer end PE device via the connected bidirectional tunnel, wherein the Notify Message indicates creation for the second PW is failed.

3. The method according to claim 1, wherein the first, second, third, fourth and fifth PW parameters each comprise: PW information, an interface parameter, and a Virtual Circuit Connectivity Verification (VCCV) parameter, and the PW information comprises a PW Identification (ID), a PW type, and a PW receiving label.

4. The method according to claim 1, further comprising:
to remove the first PW, transmitting, by the PE device, a first Withdraw Message to the peer end PE device via the bidirectional tunnel;
receiving a second Withdraw Message from the peer end PE device via the bidirectional tunnel, wherein the second Withdraw Message is in response to the first Withdrawn Message, and the first Withdraw Message carries a PW ID of the first PW to be removed by the PE device;
after receiving a third Withdraw Message via the bidirectional tunnel, wherein the third Withdraw Message is transmitted by the peer end PE device if the peer end PE device is to remove a third PW, obtaining, by the PE device, a PW ID of the third PW to be removed by the peer end PE device from the received third Withdraw Message; and
removing the third PW created by the PE device.

5. The method according to claim 1, further comprising:
associating, by the PE device, a first interface, the first PW and a second interface with each other, wherein the first interface is connected to a Customer Edge (CE) device and is in the PE device, and the first PW corresponds to a Virtual Private Network (VPN) of the CE device, and the second interface connects the PE device to the bidirectional tunnel.

6. A Provider Edge (PE) device in a Layer 2 Virtual Private Network (L2VPN) network, wherein a bidirectional tunnel is deployed between PE device and a peer end PE device in the L2VPN network, and the PE device comprises:
an interface and a processor;
the interface is to transmit a first setup message to the peer end PE device via the bidirectional tunnel, wherein the first setup message carries first PW parameters relevant with a first PW to be created by the PE device;
the interface is further to receive a second setup message from the peer end PE device via the bidirectional tunnel, wherein the second setup message is transmitted by the peer end PE device in response to the first setup message if the first PW parameters match with second PW parameters configured by the peer end PE device to create PWs; and
the processor is to obtain the second PW parameters from the second setup message.

7. The PE device according to claim 6, wherein the PE device further comprises:
a memory;
the interface is further to receive a third setup message via the bidirectional tunnel connecting with the PE device, wherein the third setup message is transmitted by the peer end PE device;
the memory is to store third PW parameters, which are relevant with all of the PWs to be created by the PE device and are configured by the PE device;
the processor is further to match fourth PW parameters, which are relevant with a second PW to be created by the peer end PE device, in the third setup message received by the interface, with the third PW parameters stored in the memory, which are relevant with all of the PWs to be created by the PE device and are configured by the PE device;
if the matching performed by the processor is successful, the interface is further to return a fourth setup message to the peer end PE device via the bidirectional tunnel, wherein the returned fourth setup message carries fifth PW parameters, which are relevant with the second PW and are configured by the PE device; and
if the matching performed by the processor is failed, the interface is further to return a Notify Message to the peer end PE device via the bidirectional tunnel, wherein the Notify Message indicates creation of the second PW is failed.

8. The PE device according to claim 6, wherein the first, second, third, fourth and fifth PW parameters comprise: PW information, an interface parameter, and a Virtual Circuit Connectivity Verification (VCCV) parameter, wherein the PW information comprises a PW identification (ID), a PW type and a PW receiving label.

9. The PE device according to claim 6, wherein if the PE device is to remove the first PW, the interface is further to transmit a first Withdraw Message to the peer end PE device via the bidirectional tunnel, the first Withdraw Message carries a PW ID of the first PW to be removed by the PE device;
the interface is further to receive a second Withdraw Message from the peer end PE device via the bidirectional tunnel, wherein the second Withdraw Message is in response to the first Withdraw Message, and the interface is further to receive a third Withdraw Message via the bidirectional tunnel connecting with the PE device, wherein the third Withdraw Message is transmitted by the peer end PE device if the peer end PE device is to remove a third PW;
the processor is further to obtain a PW ID of the third PW from the third Withdraw Message received by the interface, wherein the third PW is to be removed by the peer end PE device; and
the processor is further to remove the third PW created by the PE device based on the obtained PW ID of the third PW to be removed by the peer end PE device.

10. The PE device according to claim 6, wherein the processor is further to associate a first interface, the first PW and a second interface with each other, wherein the first interface connecting to a Customer Edge (CE) device is in the PE device, the PW corresponds to a Virtual Private Network (VPN) of the CE device, and the second interface connects the PE device to the bidirectional tunnel.
